(19) United States
(12) Patent Application Publication
(10) Pub. No.: US 2005/0052458 A1
(43) Pub. Date: Mar. 10, 2005

(54) Graphical user interface for computer-implemented time accounting

(76) Inventor: Jaron Lambert, Calgary (CA)

Correspondence Address: JAMES D IVEY, 3025 TOTTERDELL STREET, OAKLAND, CA, 94611-1742, US

(21) Appl. No.: 10/658,738

(22) Filed: Sep. 8, 2003

(51) Int. Cl. G06T 11/20

(52) U.S. Cl. 345/440

(57) ABSTRACT

Time records of a professional are represented along a time line to provide readily accessible quantitative summary of time spent by the professional. The time records are represented as bars which represent transitions from one task to another and shades between the bars. Graphical user interfaces (GUIs) are associated with the bars and shades allow easy and intuitive entering and editing of time records.

### FIELD OF THE INVENTION

This invention relates to the field of computer-implemented graphical user interfaces (GUIs, sometimes referred to as human-machine interfaces—HMI), and more specifically to a particularly efficient graphical user interface for computer-implemented time accounting such as used by service professionals charging an hourly rate.

### BACKGROUND

A number of professionals bill at hourly rates for professional services rendered. When speaking of billable hours, attorneys come to mind. However, other professionals whose income is determined by the billable hour includes, for example, accountants, consultants, and software engineers. One persistent clerical task associated with professional services and which requires complete vigilance is time accounting, namely, the accurate recording and subsequent reporting of the amount of time spent on various tasks.

Some systems require that the professional simply remember time spent during a day and to record such time at the end of the day for entry into a time accounting database. Other systems permit the professional to use a computer with a built-in clock such that start and stop times for tasks are recorded automatically by the computer. Examples of such systems include (i) Timeslips by Best Software SB, Inc. of Norcross, Ga.; (ii) GtimeTracker by Eckehard Berns et al. for the Gnome desktop environment of the Linux operating system; and (iii) TimeSleuth (http://www.timesleuth.org/) for the Qtopia and Opie environments for the Linux operating system running on personal digital assistants such as the Sharp Zaurus SL-5500. Such systems generally allow the professional to subsequently and manually modify the start and stop times.

Allowing for manual editing of time spent on various tasks is important. It is nearly impossible for a professional to accurately record start and stop times of work on specific tasks as those tasks are started and stopped. For example, one task may be interrupted and billing might not be stopped if the interruption is mistakenly believed at the outset to be very brief but ends up taking appreciable time. Or the professional may forget to start or stop recording the time of a task altogether. In such cases, the professional must estimate an amount of time by which to correct the time accounting and must edit the time records to reflect the adjustment. Such manual editing is both unnecessarily inconvenient and risks improperly representing an instance of doubling billing in which the professional appears to be billing two or more clients for the same period of time.

Manual editing generally requires that the professional pick a time record to be adjusted or to create a new time record. The professional then determines the amount of time by which to adjust the time record and modifies start and/or stop times of the time record to effect the time adjustment. While most professionals are generally capable of time arithmetic, most professionals would prefer to devote attention to their work rather than to accounting for all the minutes of the day.

What is needed is a mechanism by which professionals can easily and efficiently enter and correct time records reflecting time spent by the professional working on various tasks.

### SUMMARY OF THE INVENTION

In accordance with the present invention, bars and shades along a time line represent individual sessions of tasks performed by a person. Bars represent start times for each session. A session implicitly ends at the next bar which defines the start of another session. A “break” task represents no task at all. Accordingly, a break bar represents the start of no task at all, and therefore represents the end of any preceding sessions.

Between the bars, shades along the time line identify tasks performed during the contiguous blocks of time represented by the shades. The tasks can be identified by the color of the respective shades, for example.

The combination of bars and shades on a time line provide a quick and easily accessible—quantitative summary of time spent by the person on various tasks. For example, many shades of different colors represent many brief sessions at many tasks. Few, long shades represent extended periods of time spent on relatively few tasks. A time line dominated by shades of a particular color represent time which is dominated by a single task, and the particular color identifies the task. A time line with few shades represents a time of poor productivity.

In addition to the intuitive and accessible quantitative summary provided by bars and shades on a time line, the bars and shades provide a simple, intuitive and efficient graphical user interface by which a user can enter and modify time records. The bars provide easy and intuitive GUIs for modifying the start and stop times of individual sessions. The shades provide easy and intuitive GUIs for modifying other aspects of individual sessions.

To create a bar, the user selects a task and clicks at a time on a time line. A new bar is created to represent a session of the selected task beginning at the clicked upon time. Another new bar is created in the same manner to define the start of another session, implicitly terminating the session which starts at the previously created bar. In addition, both bars can be created in a single drag-and-drop GUI gesture. Clicking on the time line creates the first bar in the same manner. Dragging causes a second bar to be created, thus defining both limits of the time block of the session. As the user continues to drag the cursor, the second bar is moved with the cursor. The user then drops the second bar. The single drag-and-drop gesture by the user is a very efficient and intuitive user interface for specifying a block of time spent on a particular task.

The user interface for modifying time records is equally intuitive and efficient. To modify the time one task ends and another starts, the user simply drags and drops the bar which defines that task transition. The single user gesture causes both sessions to be modified: both the stop time for the earlier session and the start time for the later session. Accordingly, inadvertent specification of inconsistent time records is avoided automatically.

In dragging and dropping a bar to modify a session in this manner, a user may reduce duration of a session to zero, implicitly deleting the session. For example, if a user drags and drops a bar at the time represented by another bar, the time therebetween is zero—effectively deleting any session between the bars. Such is found to be counterintuitive to users. It is unsettling to many users when data is automatically deleted. To avoid such implicit and automatic deletion of sessions, other bars are moved to accommodate the time as modified by the user. For example, if a bar is moved to a later time and dropped onto another bar, the other bar is also moved to a later time such that the session between the two bars is at least a predetermined minimum time increment. From the users perspective, the second bar appears to be “bumped” by the dragged and dropped bar. Such bumping is recursive such that no session is implicitly deleted.

Under certain circumstances, recording time spent on more than one task in a given time period is appropriate and carefully managed according to the present invention. In particular, a side session represents time spent on a task where the same time can still be recorded as spent on another task. Side sessions are limited to a predetermined minimum time increment, such as six minutes for example. Side sessions are also limited as to number at any given time.

The following example illustrates the usefulness of side sessions. Consider that a professional bills time in six-minute increments and any time spent on a task is billed at a minimum of six minutes. If the professional spends two minutes on each of three different tasks in a given six-minute time period, such is recorded as one six-minute session and two six-minute side sessions associated with the same six-minute period.

The user interface associated with side sessions is also intuitive and simple for the user. An area along side the time line is used for side sessions. The user can drag a task item and drop it in that area to create a side session.

Dragging and dropping a task item on to a shade changes the task represented by the shade.

In an approval mode, time sessions are approved by a time approver (such as a supervisor or manager) by simply clicking on shades. Clicking a shade toggles the session associated with the shade between an approved state and an unapproved state. In the approval mode, the cursor takes on a rubber-stamp appearance when over a shade that can be approved/unapproved.

The overall result of such representation of time spent on various tasks and the user interface by which such time is entered is highly intuitive and simple for users to both see quantitative assessment of such time in the time line form and modify time as entered with quality controls.

### BRIEF DESCRIPTION OF THE DRAWINGS

FIG. 1 is a screen view of a time line showing time spent on various tasks in accordance with the present invention.

FIG. 2 is a block diagram of a computer system which includes a time accounting user interface in accordance with the present invention.

FIG. 3 is a screen view of the time line of FIG. 1 in greater detail.

FIG. 4 is a screen view of the task list of FIG. 1 in greater detail.

FIG. 5 is a screen view of a note of a session associated with the time line of FIGS. 1 and 3.

FIGS. 6 and 7 are screen views illustrating a user interface in which the user modifies times along the time line of FIGS. 1 and 3.

FIGS. 8 and 9 are screen views illustrating a user interface in which the user modifies a task associated with a shade along the time line of FIGS. 1 and 3.

FIGS. 10 and 11 are screen views illustrating a user interface by which the user creates a side session adjacent to the time line of FIGS. 1 and 3.

FIGS. 12-15 are screen views illustrating bumping of a bar by movement of another bar in accordance with the present invention.

FIGS. 16 and 17 are screen views illustrating approval of time records in accordance with the present invention.

### DETAILED DESCRIPTION

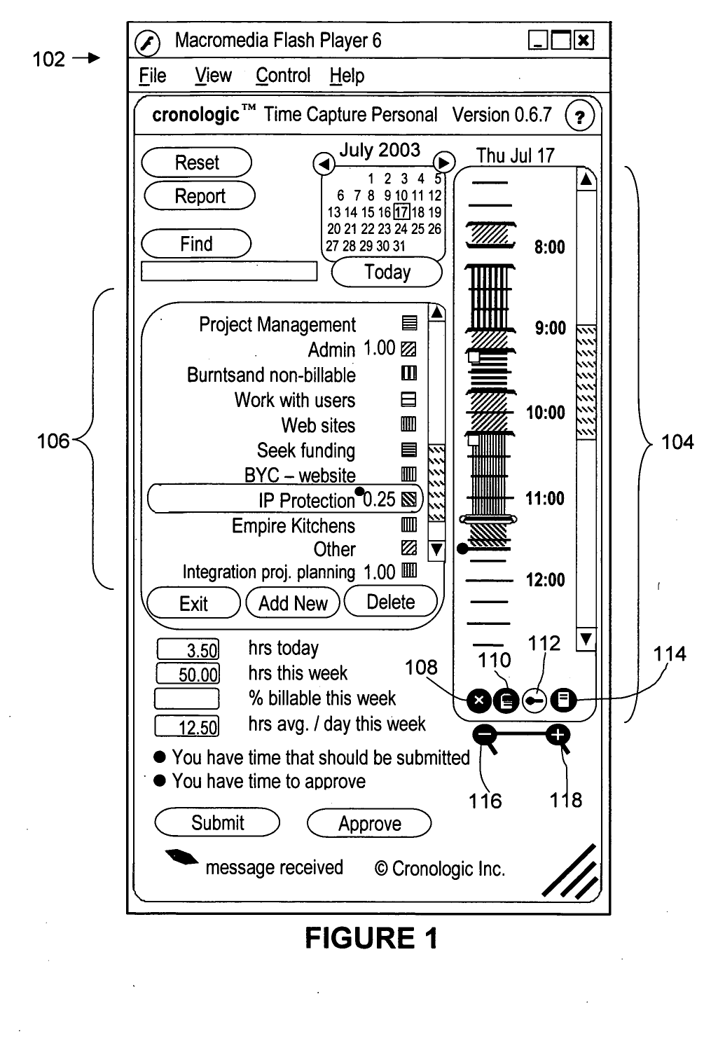

In accordance with the present invention, computer display 102 (FIG. 1) which represents a graphical user interface (GUI) in which a time line 104 represents time records representing sessions of work of a professional in furtherance of completing various tasks. Time line 104 both represents time spent so far on various tasks in an intuitive and easily accessible manner and also includes user-manipulatable GUI objects to allow intuitive editing of those time records.

The nature of tasks represented on time line 104 depends on the particular organization of work chosen by the professional for whom time is to be tracked. For example, if the professional is a software engineer working as an independent contractor on various projects for which time can be billed, each task represents a project. On the other hand, if the professional is an attorney, each task can represent a matter for which the attorney represents a client. In this latter context, examples of tasks can include a specific litigation matter, preparation and negotiation of a specific license of intellectual property, and a patent application which the attorney is to draft and prosecute to issuance. Generally, it is within the user's discretion to determine categories of time which are meaningful to the user.

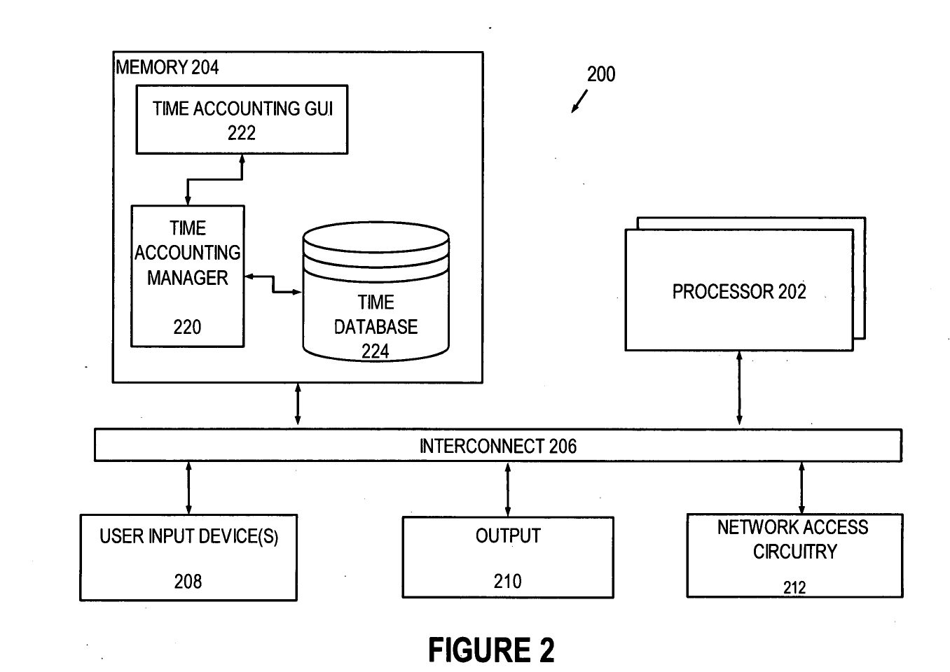

Graphical user interfaces and GUI objects generally are known and are only briefly introduced herein to facilitate appreciation and understanding of the present invention. The graphical user interface described herein in accordance with the present invention is implemented by a computer, e.g., computer 200 of FIG. 2.

Computer 200 includes one or more microprocessors 202, each of which retrieves data and/or instructions from memory 204 and executes retrieved instructions in a conventional manner. Memory 204 can include generally any type of computer-readable memory such as randomly accessible memory (RAM), read-only memory (ROM), and persistent storage media such as magnetic and/or optical disks.

Microprocessors 202 and memory 204 are connected to one another through an interconnect 206 which is a bus in this illustrative embodiment. Interconnect 206 is also connected to one or more user input devices 208, one or more output devices 210 (FIG. 2), and network access circuitry 212. Input devices 208 generate signals in response to physical manipulation by a human user and include, for example, electronic mice, trackballs, touch pads, keyboards, keypads, speech recognition logic, and touch-sensitive screens. Output devices 210 present information to the human user and include typical computer display devices such as CRTs, LCDs, and touch-sensitive screens and can also include audio output devices such as sound circuitry and loudspeakers. Network access circuitry 212 can be generally any network connection such as a modem or any type of ethernet network adapter for example.

Memory 204 includes a time accounting manager 220, a time accounting GUI 222, and a time database 224. In this illustrative embodiment, time accounting manager 220 and time accounting GUI 222 are each all or part of one or more computer processes executed by microprocessors 202 from memory 204. Time database 224 is a collection of organized data which is accessible by time accounting manager 220.

As is typical when describing GUIs, GUI objects are said to perform actions and have behaviors. As is generally understood, such means that—when executed within computer 200—a GUI represents objects in output devices 210 and represents such objects to have behaviors (e.g., by moving and/or changing the represented objects) in response to signals received from user input devices 208. Thus, the GUI represents objects in such a way that the objects appear to be responsive to physical manipulation of user input devices 208 by a human user. Clicking, dragging, and dropping are well-known GUI behaviors of GUI objects and are not described further herein.

Returning to FIG. 1, display 102 is presented by time accounting GUI 222 and behavior of various GUI objects represented in display 102 is implemented by time accounting GUI 222. Time line 104 both represents a history of time spent on various tasks and provides an intuitive GUI for editing data representing that history. Display 102 also includes a task list 106 in which a number of task items are represented. The task items of task list 106 are presented in time database 224 and are controlled by time accounting manager 220. Time accounting GUI 222 effects changes to data in time database 224 through time accounting manager 220.

As shown, each task item of task list 106 is associated with a color. The associated colors are used by time accounting GUI 222 in time line 104 to identify the specific task performed during a particular time.

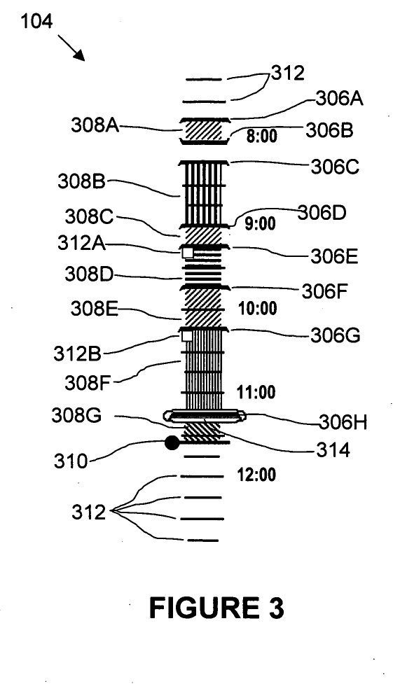

Time line 104 is shown in greater detail in FIG. 3. Tick marks 312 mark quarter-hours on time line 104. In this illustrative embodiment, start and stop times are limited to those times represented by tick marks 312, namely, at integer increments of 15 minutes. Also, in this illustrative embodiment, such a time interval is configurable by the user, e.g., by using a properties and/or preferences user interface dialog. Other intervals can include six minutes and one minute, for example. If the interval is six minutes, a session is only permitted to start or stop at times including integer multiples of six minutes—therefore permitting billing in tenths of hours. In other words, a session can only start or stop at times ending with :00, :06, :12, :18, . . . :54. As used herein, a session is a contiguous time period during which work is performed for a specific task.

In an alternative embodiment, sessions can start at any time but are rounded according to the billing increment, e.g., 15 minutes, six minutes, or one minute.

Time line 104 includes bars 306A-H, each of which represents a transition from one session to another. By representing transitions, bars 306A-H represent a start time for one task and, implicitly, a stop time for another task. Bar 306B is a break bar since no task immediately follows bar 306B, therefore representing the start of a break in work. In other words, bar 306B represents the start time of a null task. Time line 104 also includes shades 308A-G each of which represents a respective session defined by a pair of bars. Each of shades 308A-G is represented in a color which corresponds to the particular task item of task list 106 (FIG. 1) represented by the shade. Such provides quick and intuitive identification to the user as to which task corresponds to each shade.

Note indicators 312A-B (FIG. 3) represent notes associated with shades 308D and 308F, respectively. Notes represented by note indicators 312A-B allow the user to annotate a specific session and to later have such an annotation included in time reports in a manner described more completely below.

In time line 104, a phantom bar 310 represents the current time. Time accounting GUI 222 (FIG. 2) moves phantom bar 310 as time passes such that phantom bar 310 continuously represents the current time on the current day. Shade 308G immediately before phantom bar 310 indicates the task currently being performed by the user. As phantom bar 310 moves over time, shade 308G grows to fill space left behind phantom bar 310. Time accounting GUI 222 stops growing of shade 308G only when the user inserts a new bar to terminate the current session. If no shade is shown immediately before phantom bar 310, the user is shown to be currently on a break.

Thus, time line 104 provides an immediately accessible quantitative summary of time spent by the user. For example, a time line with many small shades of many colors represents many brief sessions on many different tasks. A time line with long shades of only one or two colors represents long sessions on one or two tasks. A time line with few shades, and therefore significant white space, represents significant amount of unproductive time. Time lines can be aggregated in week views or month views, for example, and the collage of bars and shades provides immediately accessible and understandable quantitative summary of time spent on various tasks as well as overall productivity and trends and patterns.

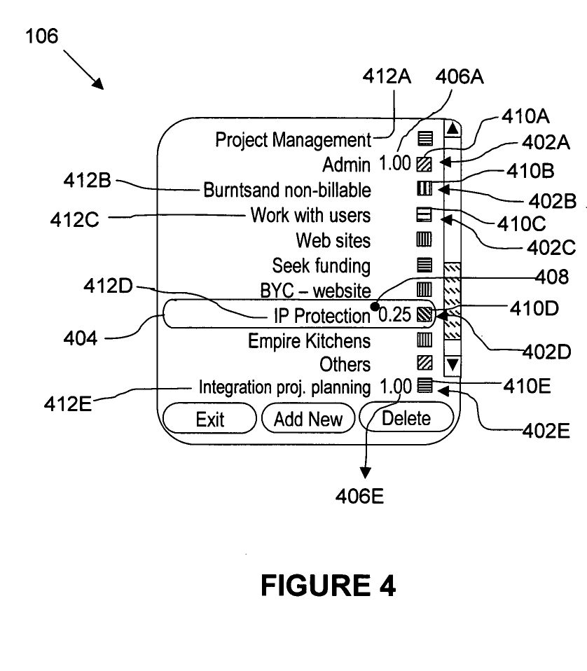

FIG. 4 shows task list 106 of FIG. 1 in greater detail. Task list 106 includes task items, such as task items 402A-E, each of which represents a particular task at which the user can spend time. Each task item has an associated color and description. For example, task items 406A-E have associated colors 410A-E, respectively, and associated descriptions 412A-E, respectively. Task items for which time has been recorded indicate the amount of time recorded for the current day, perhaps including multiple sessions. For example, task item 402A has a time total 406A which indicates that the user has recorded a total of 1.00 hours performing administrative tasks throughout the current day.

Only one of the task items of task list 106 is permitted to be active at any given time. Selected task indicator 404 identifies the selected task for the user, e.g., the task represented by task item 402D in this illustrative example. A phantom indicator 408 indicates the task item, if any, for which phantom bar 310 (FIG. 3) is currently active.

Time accounting GUI 222 (FIG. 2) implements a particularly intuitive and simple user interface whereby time accounting GUI 222 permits very simple user gestures to manage accounting of time. For example, to record the start time of a particular task, the user selects a task item by clicking on the task item in task list 106 (FIG. 1) and, with that task item selected, clicks on a tick mark 312 (FIG. 3) of time line 104. Thus, only two user interface gestures are required to record a start time for a session spent on a particular task. If the desired task is already selected (if the most recently recorded task was the desired task item, for example), only a single user input gesture of clicking on a tick mark 310 is required.

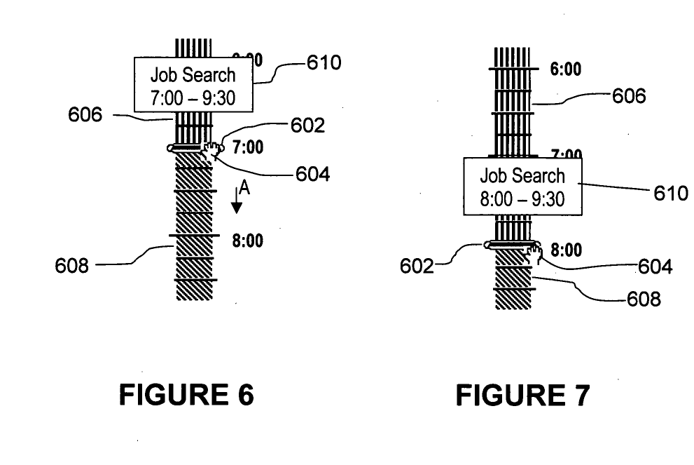

As the user proceeds to click on a tick mark 310, the cursor hovers over time line 104. Cursors are well-known components of GUIs and are not described further herein. When the cursor is over time line 104, a text box associated with the cursor represents precisely what time would be selected if the user clicked with the cursor in its current position. Examples of such a text box are shown in FIGS. 6 and 7. Such a text box allows the user to precisely pick a start time for the current session.

In this illustrative embodiment, time accounting GUI 222 (FIG. 2) only permits the user to select times associated with tick marks 310 (FIG. 3). In an alternative embodiment, time accounting GUI 222 permits the user to pick integer multiples of a time recording precision, e.g., one or six minutes, while tick marks 310 are shown at a different time interval, e.g., 15 minutes. However, the general user interface is as described above for this alternative embodiment as well except that the user is permitted to pick times not falling directly on a tick mark 310.

To record a stop time for a session, the user merely repeats the steps above with a different task item selected. Time accounting GUI 222 interprets the start of a session for a different task item as the implicit termination of the prior session. A task item for break time is provided in task list 106 by time accounting GUI 222. Recording the start of a break session is interpreted by time accounting GUI 222 as recording the stopping of any session for any task.

Time accounting GUI 222 also implements an even simpler user interface for rapid session entering. Rather than simply clicking on a starting time on time line 104, the user clicks the start time on time line 104 and drags the cursor to a stop time and drops a bar there. In other words, the user moves the cursor to a start time, presses a button (e.g., on a mouse or trackball), moves the cursor to a stop time, and releases the button. Thus, a single, familiar user gesture creates a session representing both start and stop times. The user can also click first on a stop time and drag to a start time (in essence, dragging against the represented flow of time).

Such a user gesture is processed by time accounting GUI 222 as follows. When the user first clicks on time line 104, time accounting GUI 222 creates a bar associated with the selected task item in the manner described above. As the user drags the cursor, time accounting GUI 222 detects such dragging in a conventional manner—typically by determining whether the cursor has moved more than a predetermined threshold distance with a user input device actuated, e.g., a button pressed or persistent stylus pressure on a touch-sensitive screen. Once dragging is detected, time accounting GUI 222 creates a second bar. The second bar represents a task item which immediately follows the selected task item and corresponds to the task of the session which previously existed at the time at which dragging began. As the user drags to a later time, the second bar is repeatedly moved such that the second bar follows the dragged cursor. In addition, the shade defined by the first and second bars is repeatedly re-drawn to provide a GUI effect which is commonly known as “rubber banding” in which the shade appears to stretch or shrink in accordance with movement of the cursor.

If the second bar is dropped on an existing bar, the second bar is deleted such that the defined session ends at the start of the immediately subsequent session.

If the user drags the cursor to an earlier time, the first and second bar swap positions such that the user drags the start time rather than the stop time. The same rubber banding effect is used.

Thus, the user interface is quite simple: select a task item (if the desired task item is not already selected), click on a time at one end of a desired session, drag to the other end of the desired session and drop at the other end of the desired session.

Time accounting GUI 222 allows a textual note to be associated with each session. The user interface is quite intuitive and direct for the user. Since notes are associated with a session, a note indicator, e.g., note indicators 312A-B, is associated with the bar starting the associated session, e.g., bars 306E and 306G, respectively. To add a note to a session, the user simply clicks note button 114 (FIG. 1) with the intended bar selected. In this illustrative example, bar 306H is selected as indicated by selected bar indicator 314. Thus, clicking note button 114 causes time accounting GUI 222 to begin creation of a note to associate with bar 306H. To edit a preexisting note, the user merely selects a bar with which a note is already associated. In this illustrative embodiment, only one note can be associated with each session. Only a single note is necessary since the user can concatenate multiple thoughts into a single note.

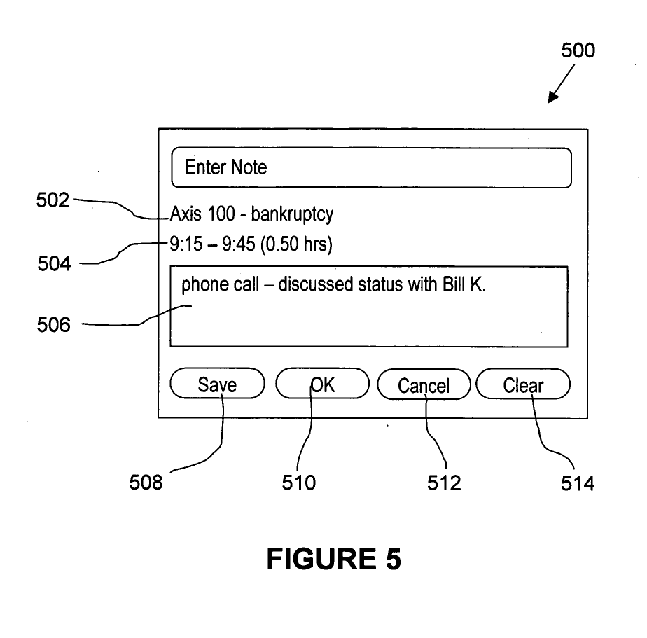

When the user clicks note button 114, time accounting GUI 222 presents the user with a note editing dialog. An example of such a dialog is shown in FIG. 5. Note editing dialog 500 includes a task description 502, a time description 504, and a note body 506. Task description 502 corresponds to the description of the task corresponding to the selected bar. Examples of such task descriptions include descriptions 412A-E (FIG. 4). Time description 504 represents the start and stop times and duration of the session associated with the selected bar. Such times and duration are defined as described above with respect to FIG. 3.

Note body 506 is a text box in which the user is free to enter and/or modify text which provides the substantive content of the note to be associated with the selected bar.

In response to clicking of save button 508 by the user, time accounting GUI 222 causes any changes made by the user to note body 506 to be written to persistent storage and to thereby save text body 506 for future reference.

In response to clicking of OK button 510 by the user, time accounting GUI 222 causes any changes made by the user to note body 506 to be written to persistent storage and closes note editing dialog 500. Thereafter, time accounting GUI 222 returns to the user interface presented to the user just prior to note editing dialog 500.

In response to clicking of cancel button 512 by the user, time accounting GUI 222 closes note editing dialog 500 without writing any changes to note body 506 made by the user to persistent storage. Thus, no changes are made with respect to any note associated with the selected bar. Thereafter, time accounting GUI 222 returns to the user interface presented to the user just prior to note editing dialog 500.

In response to clicking of clear button 512 by the user, time accounting GUI 222 erases all content of note body 506. Saving a cleared note causes any note associated with the selected bar to be deleted.

Notes are included on time reports and provide useful reminders as to what specific actions were taken during the time spent on a particular task. In preparing such reports, time from multiple sessions can be aggregated. For example, in a report which includes time spent on various tasks for each day, multiple sessions are accumulated to provide a single amount of time spent on each task for the entire day. Other units for reporting can include weekly, monthly, yearly, etc. When aggregating sessions for a single report item, not only is time accumulated, but all notes associated with the aggregated sessions are concatenated to provide a single description of the work represented by the aggregated sessions. In one embodiment, the notes are delimited by two space characters to represent typical punctuation between sentences. In an alternative embodiment, the user is permitted to select a preferred delimiter to be inserted between notes.

Time accounting GUI 222 provides a particularly intuitive mechanism for the user to modify times associated with bars which have already been specified. For example, FIG. 6 shows a selected bar 602 which indicates that the user recorded that the user worked on the Job Search task from 7:00 to 9:30. Consider that the user has determined that she actually worked on that task from 8:00 to 9:30. For example, the user may have entered time spent away from a computer after the fact and merely erroneously placed bar 602 on the wrong tick mark. Other scenarios can be imagined in which the user has specified the wrong start time for a session. For example, the user may have legitimately stopped work on the prior task at 7:00—and recorded that by placing bar 602 at 7:00—but was immediately interrupted by a phone call for the prior task (represented by shade 606).

To change the start time associated with bar 602, the user places cursor 604 over bar 602 and moves bar 602 in the direction of arrow A using a conventional and familiar drag and drop user interface, dropping bar 602 at the time 8:00. A floating text box 610 continually reports the current start time associated with the dragged bar to assist the user in precise placement of bar 602.

The result of such dragging and dropping is shown in FIG. 7. Bar 602 is at 8:00 (as indicated by floating box 610). Shade 606 extends to 8:00 at which time shade 608, whose start time is associated with bar 602, begins.

It should be noted that the single drag-and-drop user interface technique caused modification of two separate sessions. First, the user gesture described above with respect to FIGS. 6-7 modified explicitly the start time of the session represented by shade 608. Second, the user gesture also implicitly modified the stop time of the immediately preceding session represented by shade 606. In conventional time account systems, the user would have had to modify two (2) separate time records to modify the start time of one time record and the stop time of another record to ensure that the time records don't overlap. In addition, such modification generally requires that the user enter a modified time textually, performing time arithmetic which, though not extremely difficult, is nonetheless tedious, distracting, and annoying for a busy professional.

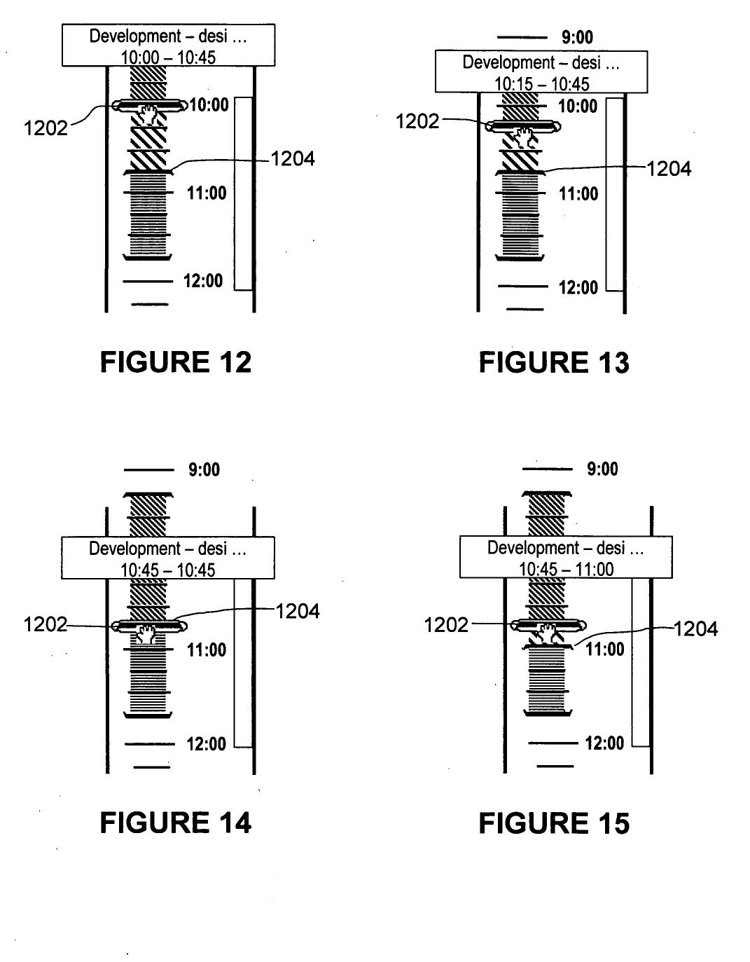

FIGS. 12-15 illustrate behavior implemented by time accounting GUI 222 when a user appears to modify a session length to zero. Specifically, time accounting GUI 222 avoids implicit deletion of sessions, assuming instead that users would prefer to have sessions deleted only explicitly in the manner described more completely below.

FIG. 12 shows a selected bar 1202 which the user drags (FIG. 13) in the manner described above with respect to FIGS. 6-7. In FIG. 14, the user has dragged bar 1202 over bar 1204 such that any session therebetween has a duration which is effectively zero—which is, in effect, an implicit deletion of that session. To avoid such implicit deletion, time accounting GUI 222 moves the obscured bar, e.g., bar 1204, such that the session between bars 1202-1204 has a duration of at least a single time increment as shown in FIG. 15. This is sometimes referred to herein as “bumping” since the obscured bar appears to be bumped by a dragged bar. Time accounting GUI 222 implements such bumping recursively. Specifically, if the bumped bar, e.g., bar 1204, would obscure another bar, that other bar would be bumped as well. This recursion continues until a bumped bar is moved to a time not already occupied by another bar.

If the user intends to delete the session between bars 1202-1204, the user simply deletes bar 1202 in the manner described below.

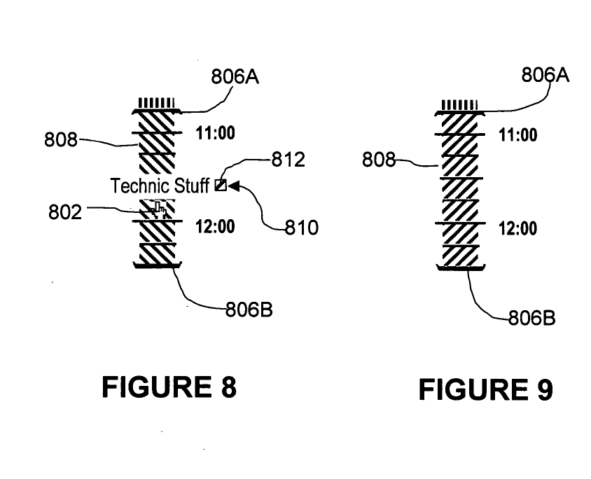

On occasion, the user may determine that she inadvertently recorded time for the incorrect task and would like to change the particular task recorded for a given session. User modification of the specific tasks represented respectively by bars 306A-H as implemented by time accounting GUI 222 (FIG. 2) is intuitive and easy for the user. An illustrative example of the user interface is shown in FIGS. 8-9. Bar 806A defines the starting time of a session which is represented by a shade 808. Shade 808 is displayed by time accounting GUI 222 as green which is the color associated with the task item currently represented by bar 806A in this illustrative example. The ending time of the session is represented by a bar 806B which is a break bar in this illustrative example.

To change bar 806A to represent a start time for a different task item, the user uses the familiar drag-and-drop gesture to drag a task item, e.g., any of the task items shown in FIG. 4, and drop the task item onto shade 808 (FIG. 8). In this illustrative example, the user drags task item 810 using cursor 802. As shown, task item 810 includes a task color 812 which is red. In response to dropping by the user of task item 810 onto shade 808, time accounting GUI 222 modifies data associated with bar 806A such that bar 806A subsequently represents a start time for the dropped task item and changes shade 808 (FIG. 9) to task color 812 of the dropped task item. As shown in FIG. 9, shade 808 as modified is red in color.

A peculiar problem for some service professionals occurs when time is charged for a minimum block of time. Consider an attorney who charges by the tenths of hours and charges 0.1 hours for any portion of a six-minute block of time. It's possible that a very brief interruption, e.g., by a telephone call, can result in the billing of a single 0.1-hour increment to two clients—both the client for whom the attorney was working when interrupted and the client by whom the attorney was interrupted.

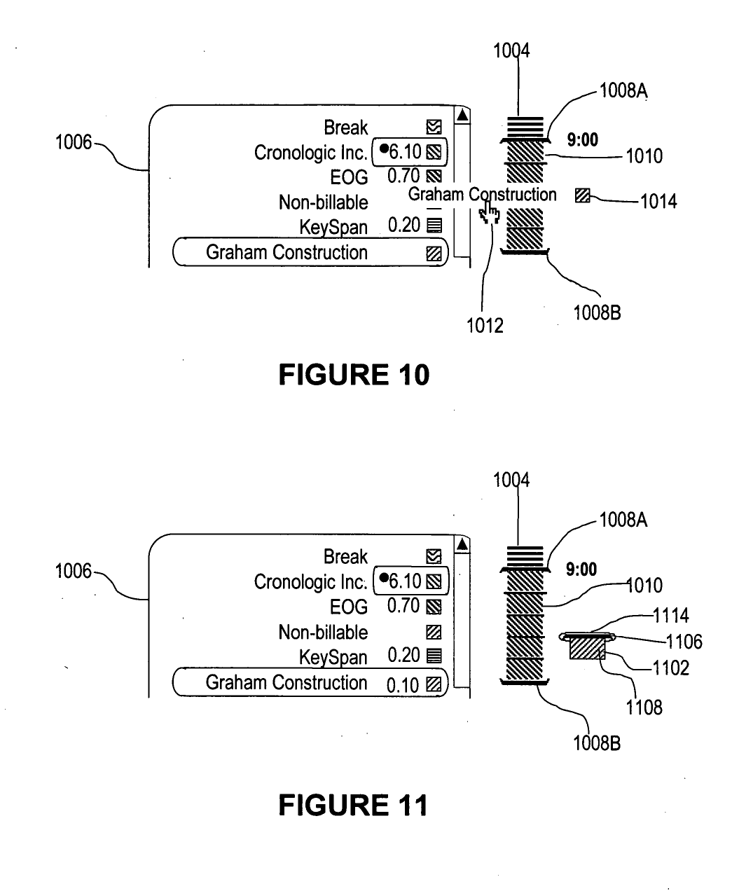

Time accounting GUI 222 provides a user interface by which the user can account for time in that manner as shown in FIGS. 10-11. In FIG. 10, time line 1004 represents work performed by the user and includes bars 1008A-B which define time spent working on a first task. To record time for a second task in the same time frame, time accounting GUI 222 implements a drag-and-drop interface by which the user drags a task item 1014 from task list 1006 and drops task item 1014 in an area to the right of time line 1004. It should be noted in the context of FIGS. 10-11 that time line 1004 is defined such that each tick mark represents 0.1-hour (6-minute) time units.

In response to the dropping of task item 1014 to the right of time line 1004, time accounting GUI 222 displays a side session 1102 (FIG. 11). Side session 1102 is represented by a bar 1106 which represents the start time for side session 1102 and a shade 1108 which is limited by time accounting GUI 222 to a single time unit and therefore does not require a bar to terminate the session. As described above with respect to other shades, the color of shade 1108 matches that of dropped task item 1014 to help identify task item 1014 as the task to which side session 1102 pertains. In this illustrative embodiment, up to two (2) side sessions are permitted for any single increment of time. In an alternative embodiment, the maximum number of permissible side sessions is specified by the user.

Thus, task list 106 and time line 104 combine to provide a simple graphical user interface for creating a new bar, modifying an existing bar, and creating a side bar representing a side session. A number of user interfaces can be employed to distinguish between these different actions.

In a first embodiment, time accounting GUI 222 distinguishes between clicking on time line 104 with a task item selected and dragging and dropping a task item onto time line 104. In addition, time accounting GUI 222 distinguishes regions, namely, the region of time line 104 itself and a region adjacent to time line 104 in which side sessions are represented.

Time accounting GUI 222 creates a new bar in response to the user clicking on time line 104 rather than dropping a dragged task item. In addition, time accounting GUI 222 in this first embodiment distinguishes from time line 104 and a region to the right of time line 104 for specifying normal sessions vs. side sessions. For example, the user can drag a regular bar, e.g., bar 306D (FIG. 3), to the right to cause bar 306D to define a side session rather than a normal session. Conversely, the user can drag bar 1106 (FIG. 11) of side session 1102 to the left on to time line 1004 to cause bar 1106 to define a regular session, representing a termination of the session represented by bar 1008A. In an alternative implementation, side sessions can be dropped on either the right or left side of time line 1004.

In a second, alternative embodiment, time accounting GUI 222 implements the same drag-and-drop interface for all three actions and, in response to any drag-and-drop action by the user, presents a dialog by which the user is asked to specify the intent. For example, in the drag-and-drop example of FIG. 10, time accounting GUI 222 in this second embodiment queries the user to specify whether the user intended, by the dropping action, to (i) create a new session starting at 9:18, terminating the prior session at 9:18; (ii) change the task with which bar 1008A is associated—in the manner described above with respect to FIGS. 8-9; or (iii) create side session 1102 (FIG. 11).

In either of these embodiments, logic can be employed by time accounting GUI 222 to limit possible interpretations of user actions. For example, if the time on to which a task item is dropped is currently not associated with any task, time accounting GUI 222 presumes the user intends to create a new bar to define a new session. In addition, user-specified preferences can indicate that side sessions are not permitted. If the user has specified that side sessions are not permitted (or, alternatively, has not specified that side sessions are permitted), time accounting GUI 222 never interprets a user input gesture to represent a request to create a side session.

To assist the user in creating bars at the current time, time accounting GUI 222 provides a phantom bar 310 (FIG. 3). Time accounting GUI 222 toggles phantom bar 310 between off and on states in response to clicking of phantom button 112 (FIG. 1) by the user. Time accounting GUI 222 always represents phantom bar 310 (FIG. 3) at the current time on the current day. As time passes, time accounting GUI 222 causes phantom bar 310 to move, thereby keeping up with the current time.

To create a new bar at the current time, the user simply double-clicks on a task item in task list 106 with phantom bar 310 on. In response, time accounting GUI 222 creates a new bar representing starting of a session for the task identified by the double-clicked task item at a position near phantom 310. Time accounting GUI 222 adjusts the start time of the newly created bar according to user-preferences and/or rules governing time accounting as implemented by time accounting GUI 222 in conjunction with time accounting manager 220.

In one embodiment, time accounting GUI 222 adjusts the start time of a newly created bar through phantom bar 310 as follows. If phantom bar 310 is directly on a tick mark 312 (FIG. 3), the position of phantom bar 310 is the start time of the newly created bar and time accounting GUI 222 performs no adjustment of that start time.

If no task is associated with the current time, i.e., no session immediately precedes the current time, time accounting GUI 222 adjusts the start time of the newly created bar to the time of the tick mark representing the time immediately before phantom bar 310. If the newly created bar represents a break as described above with respect to bar 306B (FIG. 3), time accounting GUI 222 adjusts the start time of the newly created bar to the time of the tick mark 312 immediately after the time represented by phantom 310. Thus, any session adjacent to a break is expanded to represent a full time increment—at the beginning of the session and/or at the end of a session.

In all other instances, phantom bar 310 is not directly on a tick mark 312 and represents a transition from time spent on one task to time spent on another task. Under these circumstances, time accounting GUI 222 adjusts the start time for the newly created bar to be that represented by the nearest tick mark 312 to phantom bar 310. In an alternative embodiment, time accounting GUI 222 creates a side session for the minority task such that both tasks performed during the time unit are charged for the time. The minority task is the task not selected by time accounting GUI 222 for a particular time unit by adjustment of the start time of a newly created bar when two tasks are performed during that time unit.

Thus, use of phantom bar 310 as implemented by time accounting GUI 222 makes time accounting quite simple for the user. As the user transitions from one task to another, the user simply double-clicks on the task item for that task and all other time accounting matters are handled automatically by time accounting GUI 222.

Time accounting GUI 222 implements a user interface by which the user can lock or unlock all bars or individual bars to prevent inadvertent modification of locked bars. To toggle a particular bar, e.g., bar 306H (FIG. 3), between a lock and an unlocked state, the user clicks on bar 306H to select bar 306H as indicated by selected bar indicator 314 and clicks lock button 110 (FIG. 1). In one embodiment, time accounting GUI 222 represents locked bars no differently than unlocked bars but does not respond to attempts to modify locked bars through the user interfaces described herein. In an alternative embodiment, time accounting GUI 222 represents locked bars differently, e.g., with a different color or by adding a small lock icon to the representation of locked bars.

Time accounting GUI 222 responds to clicking of delete button 108 (FIG. 1) by deleting the selected bar, e.g., bar 306H. Since bars define the start of a new session and implicitly define the end of the immediately preceding session, time accounting GUI 222 responds to deletion of a bar as an implicit extension of the immediately preceding session to the time at which the deleted session was terminated—implicitly by a subsequent bar.

Time accounting GUI 222 also implements a graphical user interface by which a time approver approves or disapproves time records submitted by the user in the manner described above. In general, it is presumed that the time approver will be different than the user entering time. For example, the time approver can be someone in a supervisory role (e.g., a manager, a supervisor, etc.) or someone in a clerical position (e.g., in accounting and responsible for sending out time bills and/or for managing time limits, perhaps on specific tasks or overall, and such things as paid time off, vacations, and the like). It is possible that the time approver and user are the same individual. For example, a self-employed professional may enter time in the manner described above and subsequently approve time records which need no further amendment as a verification step prior to sending out invoices for the time.

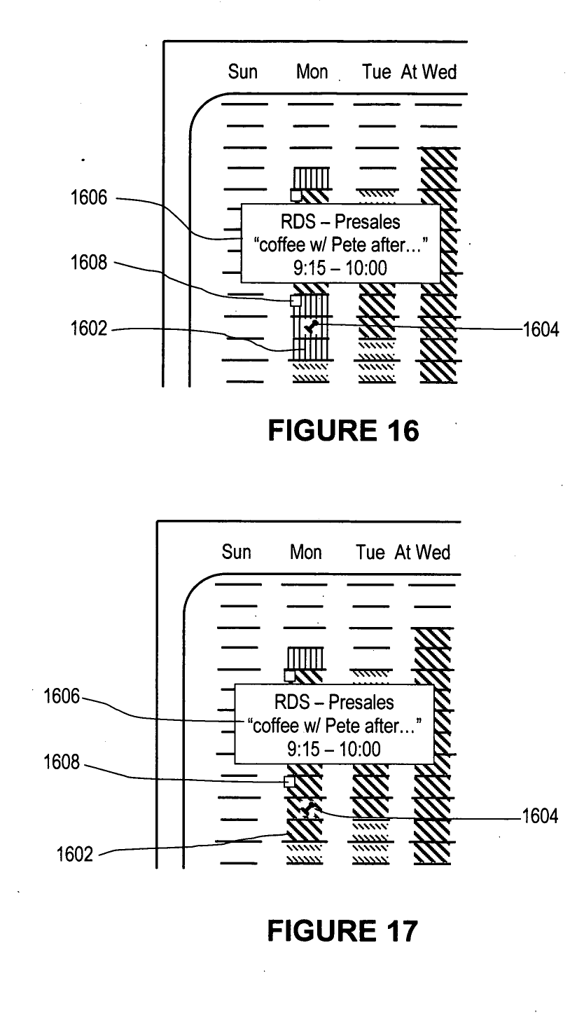

FIGS. 16 and 17 illustrate time approval as implemented by time accounting GUI 222. In one embodiment, in approval mode, the user (typically the time approver in this mode) is not permitted to modify the recorded time. Accordingly, no bars are displayed to the user since none of the user interfaces provided in conjunction with the bars described in FIG. 1-15 are available in approval mode. As shown in FIGS. 16-17, only shades are displayed. In an alternative embodiment, in approval mode, the user is permitted to modify the recorded time. Accordingly, bars are displayed and the user interfaces provided in conjunction with the bars described in conjunction with FIGS. 1-15 are available in approval mode.

Shades are shown in one of three colors. A red shade represents an unapproved session. A green shade represents an approved session. A grey shade represents a session for which approval (i) is required from another time approver or (ii) is not required. Such sessions can represent time spent on administrative and other non-billable task. To expedite the approval process, shades for several days, e.g., a week, are included in a single display.

Initially, all shades are shown in red or grey since the time approver has approved none of the sessions. One by one, the time approver approves individual sessions. FIGS. 16-17 illustrate the approval of the session represented by shade 1602. The time approver moves a cursor 1604 over shade 1602. Cursor 1604 is represented as a rubber stamp to indicate that actuation of cursor 1604, e.g., by pressing a button on a mouse or trackball, approves a session.

When cursor 1604 hovers over shade 1602, time accounting GUI 222 retrieves—e.g., from time accounting database 224—data regarding the session represented by shade 1602 and displays a floating box which summarizes the session, including identifying the task of the session, summarizing any note (represented by note identifier 1608), and displaying the start and stop times of the session.

To approve the session represented by shade 1602, the time approver merely clicks on shade 1602 with the rubber stamp cursor 1604. In response, time accounting GUI 222 modifies data in time accounting database 224 to indicate the session is approved and displays shade 1602 as green to indicate an approved session.

Other options are available to the time approver in the approval mode. For example, if the time approver wishes to see a more detailed representation of the session represented by shade 1602, the time approver right-clicks (or otherwise requests a secondary menu of options) on shade 1602. Time accounting GUI 222 displays a secondary menu in a pop-up manner, and the time approver can select a “properties” option to cause time accounting GUI 222 to display the details of the session.

The same secondary menu includes an option by which the time approver can enter reasons for disapproval. In response the selecting this option, time accounting GUI 222 provides a user interface dialog in which the time approver can enter a reason for disapproval such that the original time entering user can correct any deficiency. Time accounting GUI 222 also provides a user interface object by which the time approver can send a message to the time entering user identifying disapproved sessions. One such GUI object is another option in the secondary menu such that a message is sent regarding that specific session. Another GUI object is not associated with any shade, e.g., is a top-level pull-down menu option, and therefore causes a message identifying all unapproved sessions to the time entering user.

Thus, as implemented by time accounting GUI 222, time session approval is a very simple matter of looking at session summaries and clicking on the shades. Even the process by which sessions are rejected and the time entering user is notified is highly streamlined.

In this illustrative embodiment, time accounting GUI 222 is implemented using the Flash programming language available from Macromedia, Inc. of San Francisco, Calif. One of the advantages of using Flash to implement time accounting GUI 222 is that time accounting GUI 222 can be forwarded through a wide area network such as the Internet to client computer systems for execution there. Communications between time accounting GUI 222 and time accounting manager 220 is then carried out through the wide area network, e.g., according to the HTTPS (hypertext transport protocol, secure) protocol. Such enables users to record time in a remotely located time accounting database 224.

Many of the GUI mechanisms described above require fairly efficient processing to give fluid, continuous motion of various GUI objects described above. To implement such graphics intensive GUI objects as dragging of task items and bars and GUI behaviors as rubber-banding and bumping as described above, time accounting GUI 222 uses a doubly-linked list to represent sessions, bars, and shades currently displayed in time line 104. Doubly-linked lists provide efficient traversal in search of specific items and particularly efficient insertion, deletion, and reordering of list items. Accordingly, time accounting GUI 222 can quickly and easily modify such bars and shades without extensive searching or data processing. Thus, fluidity of GUI behaviors, even within computers having relatively limited processing resources, is enhanced.

The above description is illustrative only and is not limiting. Instead, the present invention is defined solely by the claims which follow and their full range of equivalents.

1. A method for presenting recorded time information to a user, the method comprising:
displaying at least one time line;
displaying, in association with the time line, two or more session graphical representations wherein each of the session graphical representations:
represents a respective contiguous block of time spent by a person on a respective one of two or more tasks;
graphically represents a start time for the respective contiguous block of time in relation to the time line;
graphically represents a stop time for the respective contiguous block of time in relation to the time line; and
graphically identifies the respective task represented by the session graphical representation;
associating a graphical user interface with the session graphical representations;
receiving user-generated input signals; and
modifying a selected one of the session graphical representations in accordance with the user-generated input signals.

2. The method of claim 1 wherein each of the session graphical representations includes a start time representation which specifies the start time of the session graphical representation in relation to the time line.

3. The method of claim 2 wherein the stop time of at least one of the session graphical representations is represented by the start time representation of another of the session graphical representations.

4. The method of claim 2 wherein the user-generated input signals represent a click at a time location on the time line, the method further comprising:
creating a new instance of the session graphical representations with a first time representation associated with the time location.

5. The method of claim 4 wherein the first time representation is the start time representation of the new instance of the session graphical representations.

6. The method of claim 4 wherein the task represented by the new instance of the session graphical representations is pre-selected according to user-generated task selection signals received previously to the user-generated input signals.

7. The method of claim 4 further comprising:
receiving user-generated drag signals which represent a drag user-interface event;
creating a second time representation associated the new instance of the session graphical representations in accordance with the drag signals.

8. The method of claim 7 wherein the first and second time representations are the start and stop time representations, respectively, of the new instance of the session graphical representations.

9. The method of claim 7 further comprising:
receiving additional user-generated drag signals; and
moving the second time representation along the time line in accordance with the additional drag signals.

10. The method of claim 7 further comprising:
determining that the drag signals correspond to a time along the time line which precedes the time location; and
swapping positions of the first and second time representations of the new instance of the session graphical representations.

11. The method of claim 2 wherein the user-generated input signals represent dropping of a dragged task item at a time location on the time line, the method further comprising:
creating a new instance of the session graphical representations whose start time representation is associated with the time location.

12. The method of claim 2 wherein the user-generated input signals represent a dragging of a start time representation of a selected one of the session graphical representations, the method further comprising:
moving the start time representation in accordance with the user-generated input signals.

13. The method of claim 12, further comprising:
determining that the start time representation of the selected session graphical representation as moved is coincident with a start time representation of a second one of the session graphical representations; and
moving the start time representation of the second session graphical representation to avoid being coincident with the start time representation of the selected graphical representation as moved.

14. The method of claim 1 wherein each of the session graphical representations includes a task representation which identifies the task of the session graphical representation.

15. The method of claim 14 wherein the task representation extends between the start and stop times of the session graphical representation along the time line.

16. The method of claim 14 wherein the task representation identifies the task by a color.

17. The method of claim 14 wherein the user-generated input signals identify a selected one of the two or more tasks and a task representation of a selected one of the two or more session graphical representations, the method further comprising:
modifying the task representation of the selected session graphical representation to identify the selected task.

18. The method of claim 17 wherein the user-generated input signals represent a drag and drop gesture in which the selected task is associated with a task item which is dragged and dropped on to the task representation of the selected session graphical representation by the user.

19. The method of claim 14 further comprising:
modifying a selected one of the session graphical representations from an unapproved state to an approved state in response to the user-generated input signals.

20. The method of claim 1 further comprising:
displaying, in association with the time line, a current time representation.

21. The method of claim 20 further comprising:
moving the current time representation such that the current time representation continues to represent the current time as time passes.

22. The method of claim 20 wherein each of the session graphical representations includes a start time representation which specifies the start time of the session graphical representation in relation to the time line, the method further comprising:
creating a new instance of the session graphical representations with a first time representation associated with the current time representation.

23. The method of claim 22 wherein the first time representation is the start time representation of the new instance of the session graphical representations.

24. The method of claim 1 wherein modifying the selected session graphical representation comprises:
deleting the selected session graphical representation.

25. The method of claim 1 wherein each of the session graphical representations can include a note representation.

26. The method of claim 25 further comprising:
associating a note object with a selected one of the session graphical representations in accordance with the user-generated signals.

27. The method of claim 26 further comprising:
adding the note representation to the selected session graphical representation.

28. The method of claim 1 further comprising:
in response to the user-generated input signals, creating a new instance of the session graphical representations which is chronologically coincident with another of the session graphical representations.

29. The method of claim 28 further comprising:
limiting the new instance of the session graphical representations to a predetermined maximum duration.

30. The method of claim 28 further comprising:
limiting chronologically coincident session graphical representations in number for any given time interval.

31. The method of claim 1 wherein the time line represents one day divided into uniform units of time.

32. A computer readable medium useful in association with a computer which includes a processor and a memory, the computer readable medium including computer instructions which are configured to cause the computer to present recorded time information to a user by:
displaying at least one time line;
displaying, in association with the time line, two or more session graphical representations wherein each of the session graphical representations:
represents a respective contiguous block of time spent by a person on a respective one of two or more tasks;
graphically represents a start time for the respective contiguous block of time in relation to the time line;
graphically represents a stop time for the respective contiguous block of time in relation to the time line; and
graphically identifies the respective task represented by the session graphical representation;
associating a graphical user interface with the session graphical representations;
receiving user-generated input signals; and
modifying a selected one of the session graphical representations in accordance with the user-generated input signals.

33. A computer system comprising:
a processor;
a memory operatively coupled to the processor; and
a time accounting graphical user interface module (i) which executes in the processor from the memory and (ii) which, when executed by the processor, causes the computer to present recorded time information to a user by:
displaying at least one time line;
displaying, in association with the time line, two or more session graphical representations wherein each of the session graphical representations:
represents a respective contiguous block of time spent by a person on a respective one of two or more tasks;
graphically represents a start time for the respective contiguous block of time in relation to the time line;
graphically represents a stop time for the respective contiguous block of time in relation to the time line; and
graphically identifies the respective task represented by the session graphical representation;
associating a graphical user interface with the session graphical representations;
receiving user-generated input signals; and
modifying a selected one of the session graphical representations in accordance with the user-generated input signals.
